(19) United States
(12) Patent Application Publication
(10) Pub. No.: US 2013/0339432 A1
(43) Pub. Date: Dec. 19, 2013

(54) MONITORING CONNECTION REQUESTS IN SOCIAL NETWORKS

(71) Applicants: A. Julie Kadashevich, Tyngsboro, MA (US); Jane B. Marcus, Medford, MA (US); Purvi Trivedi, Chelmsford, MA (US); Jessica Lorraine Piziak, Hudson, MA (US)

(72) Inventors: A. Julie Kadashevich, Tyngsboro, MA (US); Jane B. Marcus, Medford, MA (US); Purvi Trivedi, Chelmsford, MA (US); Jessica Lorraine Piziak, Hudson, MA (US)

(73) Assignee: INTERNATIONAL BUSINESS MACHINES CORPORATION, Armonk, NY (US)

(21) Appl. No.: 13/523,626

(22) Filed: Jun. 14, 2012

(51) Int. Cl. G06F 15/16

(52) U.S. Cl. 709/204

(57) ABSTRACT

Monitoring connection requests in social networks includes identifying a connection request to connect a contact's profile to a user's profile in the social network, comparing information about the contact's profile to a preference in the user's profile, and determining whether to allow the connection request to be sent to the user's profile based on the preference.

### BACKGROUND

The present invention relates to monitoring connection requests, and more specifically, to monitoring connection requests in social networks.

Electronic social networks include multiple users whose profiles are linked to one another. Often, those with whom a user's profile is linked are referred to as the user's “connections” or “friends” depending on the social network's platform. Users may send connection requests to others that use the social network platform to link the profiles together. The user receiving the connection request has an option to accept or deny the connection request. If the user accepts the connection request, then the profiles are automatically linked. However, if the user chooses to deny the connection request, then no connection is made.

### BRIEF SUMMARY

A method for monitoring connection requests in social networks includes identifying a connection request to connect a contact's profile to a user's profile in the social network, comparing information about the contact's profile to a preference in the user's profile, and determining whether to allow the connection request to be sent to the user's profile based on the preference.

A system for monitoring connection requests in social networks includes at least one processor to access and execute computer readable instructions stored on a computer readable storage medium, the computer readable instructions to cause the at least one processor to identify a connection request to invite a contact's profile to connect with a user's profile in the social network, compare information about the contact's profile to a preference in the user's profile; and determine whether to allow the connection request to be sent to the user's profile based on the preference.

A computer program product includes a computer readable storage medium, the computer readable storage medium having computer readable program code embodied therewith. The computer readable program code having computer readable program code to identify a connection request from a contact's profile to connect to a user's profile and computer readable program code to generate an undesirability index for the contact's profile based on a preference in the user's profile.

### BRIEF DESCRIPTION OF THE SEVERAL VIEWS OF THE DRAWINGS

FIG. 1 is a diagram showing an illustrative system for monitoring connection requests, according to one example of the principles described herein.

FIG. 2 is a diagram showing an illustrative method for monitoring connection requests, according to one example of the principles described herein.

FIG. 3 is a diagram showing an illustrative user interface display, according to one example of the principles described herein.

FIG. 4 is a diagram showing an illustrative user interface display, according to one example of the principles described herein.

FIG. 5 is a diagram showing an illustrative user interface display, according to one example of the principles described herein.

FIG. 6 is a diagram showing an illustrative processor, according to one example of the principles described herein.

FIG. 7 is a diagram showing an illustrative flowchart of a process for monitoring connection requests, according to one example of the principles described herein.

### DETAILED DESCRIPTION

The present specification describes a method and system for monitoring connection requests in a social network such that the user has control over whether the connection requests are actually received by the user.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

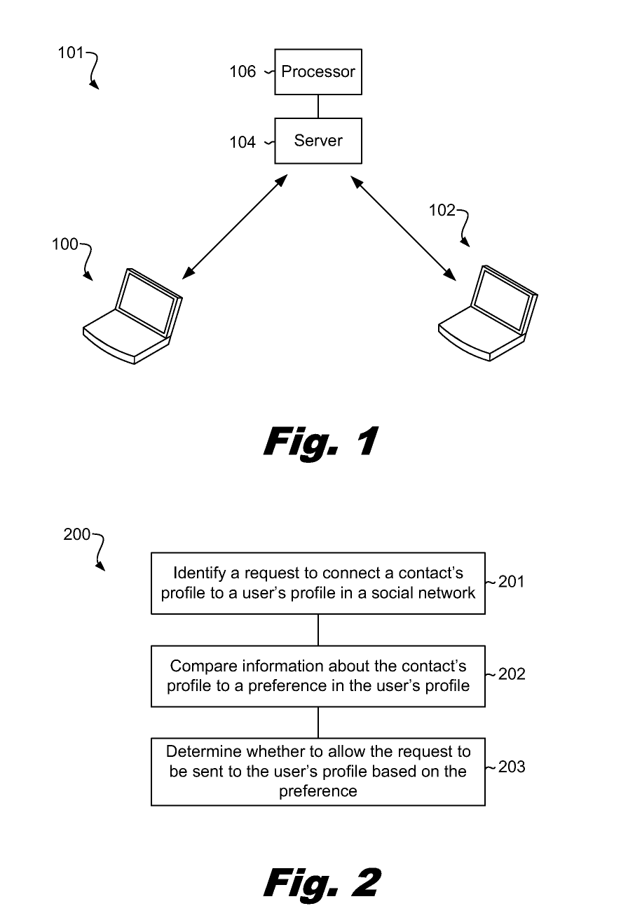

Referring now to the figures, FIG. 1 is a diagram showing an illustrative system (101) for monitoring connection requests. In this example, a first computer (100) and a second computer (102) are in communication with devices that run a social network. The computers (100, 102) may be personal computers, laptops, mobile devices, phones, electronic tablets, hand held devices, other computers, or combinations thereof. In some examples, the devices are part of a data center. The devices may include at least one server (104), tangible memory storage, network devices, at least one processor (106), communication channels, other machines, and combinations thereof. The social network may allow users to make profiles that include personal information, such as name, residual location, birthday, age, profession, likes, dislikes, other information, or combinations thereof.

The system (101) may automatically filter connection requests sent to users of the social network. The user may specify preferences that establish a user customized policy to allow or disallow connection requests to be received by the user. The system (101) may dynamically calculate an undesirability index based on the user specified preferences using information from the contact that desires to make the connection or using information found elsewhere in the social network. For example, the system (101) may use the contact's job title information, employer information, relationship information, or other information contained in the contact's profile to determine whether to allow the connection request to be sent. However, the system (101) may also use information from the contact's connections or from the user's connections to determine whether to allow the connection request to be sent. For example, if the contact desiring to make the connection has been a given a low rating by his connections or by the user's connections, the system may use that information in determining whether to allow the connection request to be sent. In some examples, the social network allows users to post comments on other social network participant's profile, and the system may use the information previously posted by the contact in those profiles to determine whether to allow or disallow the connection request to be sent.

The user may specify how much weight to give each of the user's preferences for generating the undesirability index. The user may change the preferences and/or weights as desired. In this manner, if a user receives connection requests from undesirable contacts after the user has initially created preferences, the user may change or update the preferences to customize the filtering policy to better meet the user's desires.

In some examples, the system (101) uses the user's preferences along with default rules to determine whether to allow or disallow the connection. In some examples, a network administrator specifies at least some of the preferences on behalf of the user. In some examples, the social network is controlled by a corporation, an industry organization, other organization, or combinations thereof, and the administrator may create preferences to be used in the social network.

In some examples, the user does not need to examine the contact's profile or search through other information to determine how desirable the contact is as a connection. In this manner, the user saves time, avoids embarrassing situations, and has a better overall user experience with the social network.

A user may use the first computer (100) to create a profile. The user may use his profile to request connections with his contacts by generating a connection request with his profile. The connection request may be sent from the first computer (100) to a server (104) that runs at least part of the social network. The server (104) may determine to which profile to send the connection request, and send the connection request to that profile. In the illustrated example, the contact may use the second computer (102) to receive the connection request. The contact may choose to accept or deny the connection. In some examples, the contact sends a connection request to the user, and the user may determine whether to accept or deny the connection request.

One of the devices that may run the social network may be a processor (106) that is caused by machine readable instructions to determine whether connection requests should be sent to the user's or contact's profile. In some examples, the processor (106) may determine to disallow the connection request to be sent. In other examples, the processor (106) determines to allow the connection to be sent, but sends the connection request with an alert to give the connection request recipient information to consider before the recipient determines to accept or deny the connection request.

In some examples, the processor (106) determines to disallow the connection request from being sent because the connection request recipient has a preference that certain types of connections are not to be sent. For example, a user may create a preference that indicates that when a connection request is sent from someone with a profile containing certain types of information that the connection request should not be sent. For example, the preference may indicate that any connection requests from anyone working for a specific employer, like a competitor, should be disallowed. In other examples, the user indicates that connection requests from anyone with a particular type of relationship, like a family member, to a specified individual, like an ex-boyfriend, should be disallowed. In some examples, the user specifies other preferences to disallow connection requests from certain types of contacts.

In some examples, the processor (106) determines to disallow the connection request from being sent because of the connections that the new potential connection has (secondary connections). For example, a new potential connection may be related to or known to a person who is indicated as highly undesirable in the user's profile. For example, the preference may indicate that any connection request from anyone who knows an ex-boyfriend should be denied, so no information about the user may be leaked to the ex-boyfriend who might be stalking the user. Examining the secondary connection is a time consuming task and automating this check may be very beneficial.

In some examples, the user has a preference to allow connection requests to be sent from specific types of people, but that an alert be sent with the connection request. For example, the user may specify that connection requests from anyone with a technical sales position should be allowed, but that such a connection request should be accompanied with an alert to notify the user that the connection request comes from someone employed as a technical salesman. The information from the alert may help the user determine whether to accept or deny the connection request.

While undesirable connection requests may be made at any time, a user may be more vulnerable for undesirable connection requests when the user establishes a new connection. The secondary connections from the new connection may become aware of the user or at least have greater access to the user through common discussions on the profiles of common connections. The secondary connections may desire to connect with the user due to their interaction on other profiles. However, the user may be unaware of information that may cause the secondary connection to be an undesirable connection. Thus, a system in accordance with the principles described herein may prevent the user from establishing a connection and exposing personal information such as birth dates, phone numbers, marital status, personal photos, other sensitive information, or combinations thereof to undesirable contacts. While the user may disconnect from undesirable connections after the connection is established, damage may occur as soon as the connection is made with the undesirable contact. For example, the undesirable contact may have already seen the user's sensitive information.

FIG. 2 is a diagram showing an illustrative method (200) for monitoring connection requests. In this example, the method (200) includes identifying (201) a connection request to connect a contact's profile to a user's profile in the social network, comparing (202) information about the contact's profile to a preference in the user's profile, and determining (203) whether to allow the connection request to be sent to the user's profile based on the preferences.

In some examples, comparing information about the contact's profile to a preference in the user's profile may include comparing the preference to job title information in the contact's profile, to employer information in the contact's profile, to relationship information in the contact's profile, to other information in the contact's profile, or combinations thereof. In some examples, the information is from another profile in the social network. For example, several of the contacts that have already established connections with the user may indicate in their profiles that the contact was a troublesome connection or give the connection a low connection rating. For example, the individual requesting the connection may have left obscene comments in message posts of several of the profiles of the user's connections.

In some examples, comparing information about the contact's profile to a preference in the user's profile may include comparing the user's job title information to employment information in the contact's profile to determine a job relationship. In examples where the user and the contact work for the same corporate entity, the system may compare the user's and contact's employment relationship. For example, the user may have a preference to not be connected to anyone who supervisors the department in which he works. In some examples, the system may compare the preferences to the contact's secondary connections, and if any of the secondary connections supervise the department in which the user works, the system may disallow the connection requests from being sent according to the preferences identified by the user.

In some examples, an undesirability index is generated for the connection request. The undesirability index may identify all of the information in the contact's profile that conflicts with the user's preference. The undesirability index may include a value weighted according to instructions from the user. In some examples, if the value is high enough, a processor determines to disallow the connection request.

In some examples, if the value is substantially high but fails to cross a threshold for disallowing the connection request to be sent, the processor may instead allow the connection request to be sent accompanied with an alert. In some examples, the alert includes at least one reason why the user should consider to deny the connection request. In some examples, if the value is low enough, the processor allows the connection to be sent without restriction. In some examples, the processor allows the connection to be sent, but will just allow the user to initially create a limited access connection that may withhold certain type of information in the user's profile from being visible to the contact. In some examples, the user has an option to modify the limited access connection after it is initially created. In some examples, the user has an option to give the contact greater access to information on the user's profile before the connection is created.

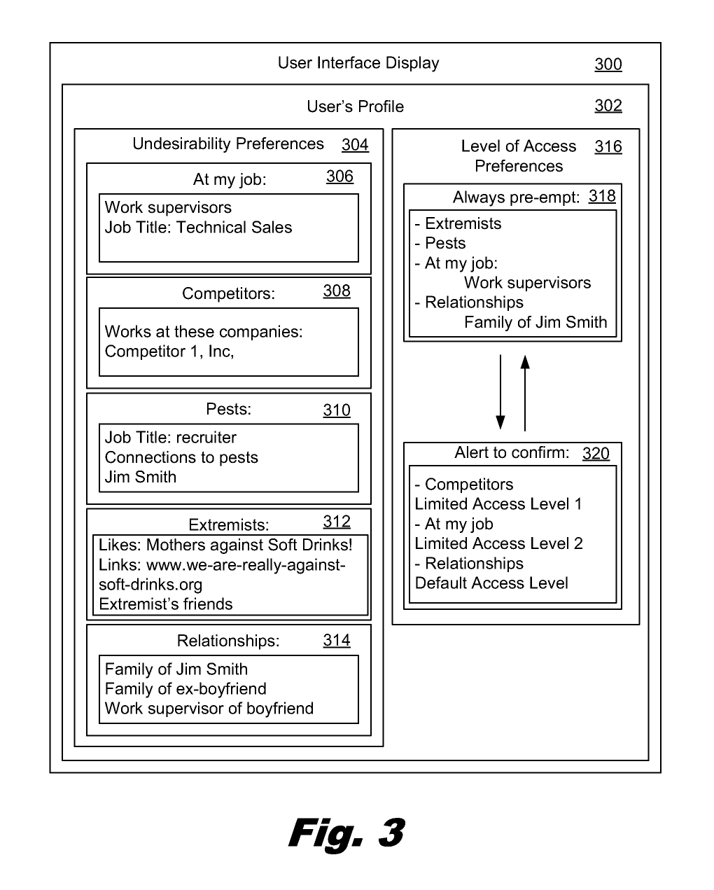

FIG. 3 is a diagram showing an illustrative user interface display (300). In this example, the user interface display (300) is displaying a user's profile (302). The user's profile (302) may contain undesirability preferences (304) that may include the user's job related preferences (306), competitor related preferences (308), pest related preferences (310), extremist related preferences (312), relationship related preferences (314), other types of preferences, or combinations thereof.

In the illustrated example, job related preferences (306) include assigning an undesirable value to work supervisors and technical salesmen. Further, in the illustrated example, the competitor related preferences (308) include assigning an undesirable value to those who work at Competitor 1, Inc. Further, in the illustrated example, the pest related preferences (310) include assigning an undesirable value to those employed as recruiters, an acquaintance of the user by the name of Jim Smith, and to those who already have connections established with those who are considered pests, such as recruiters and Jim Smith. Further, in the illustrated example, the extremist related preferences (312) include assigning an undesirable value to those who have identified in their profiles that they like an organization called “Mothers Against Soft Drinks,” those whose profiles link to a website called www.we-are-really-against-soft-drinks.org, and to those who are already connected to extremists. Explicit membership in some social network groups, like “Mothers Against Soft Drinks,” may be assigned an undesirable value. Further, in the illustrated example, the relationship related preferences (314) include assigning an undesirable value to those who are family members of Jim Smith, family members of an ex-boyfriend, and work supervisors of a current boyfriend. In some examples, the user has an association preference that applies to contacts who are part of an association or other organization that is incompatible with the user's beliefs.

In some examples, each of the identified undesirable preferences is assigned an equal weight. In other examples, each of the undesirable preferences is assigned weights chosen by the user.

The user's profile (302) may also include level of access preferences (316). In some of the examples, the level of access preference (316) includes an always pre-empt preference (318) and an alert to confirm preference (320). In the example of FIG. 3, the user has selected that those profiles that match the user's extremist related preferences (312) and the user's pest related preferences (310) to be pre-empted from sending a connection to the user's profile. Also, the user has selected that just the work supervisors from her job related preferences (306) and just the family members of Jim Smith from her relationship related preferences (314) to be pre-empted from sending a connection to the user's profile.

In the example of FIG. 3, the user has also selected specific preferences to be allowed to be sent, but accompanied with an alert to confirm preference (320). Such preferences that fall into this category include the competitor related preferences (308), the job related preferences (306), and relationship related preferences (314). In some examples, if there is overlap between preferences selected to be pre-empted from sending connection requests and those preferences selected to allow the connection requests to be sent with an alert, a policy may govern which level of access preference (316) should override the other. In some examples, the always pre-empt preferences (318) overrides the alert to confirm preferences (320).

In some examples, the user's profile (302) also has an option of selecting the level of access that a contact may initially have with the user if the user accepts the connection request. In this illustrated example, the user has specified that a first limited access level should be used for those profiles that match a competitor related preference (308), that a second limited access level should be used for those profiles that match a job related preference (306), and that a default access level should be used for those profiles that match a relationship related preference (314). The user may determine how much access is available for each access level. For example, a first limited access level may allow a limited access connection to be made that prevents the contact from having access to any of the user's personal information. In another example, the second limited access level allows a limited access connection to be made that prevents the contact from having access to any of the user's connections. In another example, a default access level connection allows a connection to be established without any restrictions. In some examples, the user's profile (302) allows the user to move the undesirable preferences (304) from one access level preference to another. In some examples, the user has the option to modify the connection's access level after the connection is initially established.

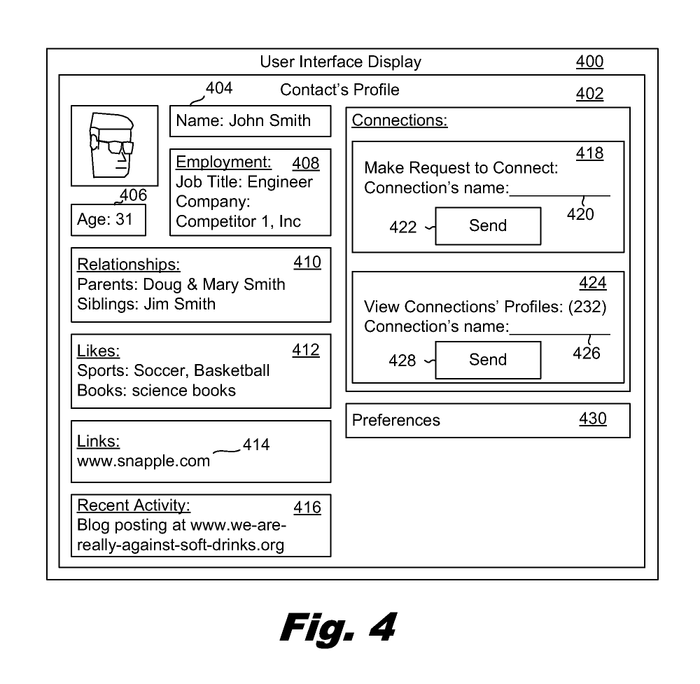

FIG. 4 is a diagram showing an illustrative user interface display (400). In this example, the user interface display (400) is displaying a contact's profile (402). In this example, the contact's profile includes personal information, such as the contact's name (404); the contact's age (406); the contact's employment information (408), such as job title information and employer information; the contact's relationship information (410), such as the contact's parents and siblings; and the contact's likes (412), such as sports and books. In some examples, the contact's profile also contains links to websites of interest to the contact. In the illustrated example, the contact's profile (402) contains a link (414) to his employer's website. Also, the contact's profile (402) may also contain a history (416) of some of the contact's recent activity. In this example of FIG. 4, the history (416) indicates that the contact recently left a blog posting at www.we-are-really-against-soft-drinks.org.

In some examples, the contact's profile (402) includes information about the contact's connections. The contact's profile (402) may contain a connection requester (418) that may contain a field (420) to identify the connection that the contact desires to make and a send button (422) to send the connection request after the field (420) has been filled in. In response to activating the send button (422), the contact's profile (402) may send the connection request to a server that has a processor that determines whether the connection request should be sent to the intended recipient.

The contact's profile (402) may have a connection directory (424) of the secondary connections of the contact's profile (402). The connection directory (424) may have a search field (426) to find the connections within the directory (424) and a send button (428) to instruct the directory (424) to find the connection identified in the search field (426). In the example of FIG. 4, the contact's profile contains 232 secondary connections.

In some examples, the contact's profile contains undesirability preferences (430) that may be used to screen incoming connection requests intended for the contact. If the contact has identified undesirable preferences (430) then connection requests from profiles that match the contact's preferences (430) may be disallowed from being sent to the contact or may be sent to the contact with an accompanying alert.

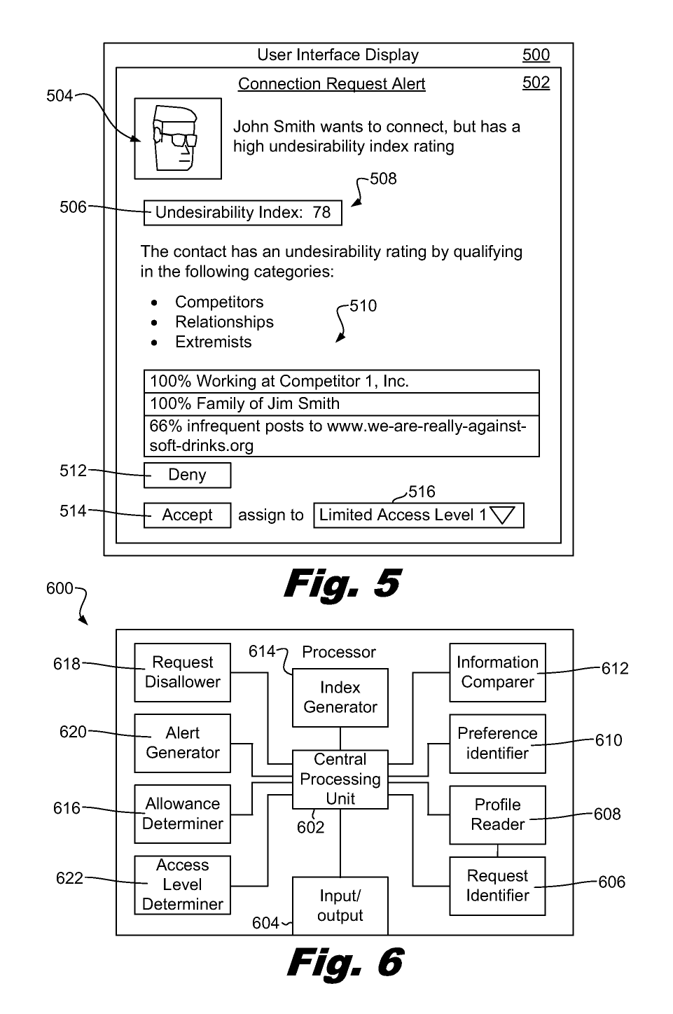

FIG. 5 is a diagram showing an illustrative user interface display (500). In this example, the user interface display (500) is displaying a connection request alert (502). The alert (502) may include an image (504) of the contact making the connection request and other information about the contact that may help the user determine whether to accept or deny the connection request.

In some examples, the alert (502) displays an undesirability index (506), which may include an undesirability value (508) that indicates how undesirable the contact making the connection request is based on the user's preferences. In the illustrated example, the alert (502) displays an undesirability index (506) with a value (508) of 78. In some examples, the undesirability index (506) is out of a range, such as one to a hundred. In other examples, there is no restriction on how high the undesirability index's value may reach.

The alert (502) may also include reasons (510) to justify the undesirability value (508). In the example of FIG. 5, the alert (502) identifies which undesirability preferences match information in the contact's preferences. In this example, the matched undesirability preferences include the competitor related preferences, the relationship related preferences, and the extremist related preferences. In this illustrated example, the competitor related preferences match the user's preferences because the contact works for a competitor specified in the user's preferences. Further, in this illustrated example, the relationship related preferences match the user's preferences because the contact is a family member of Jim Smith. Also, in this illustrated example, the extremist related preferences match the user's preferences because the contact has made recent posts to www.we-are-really-against-soft-drinks.org.

The alert (502) may contain a deny button (512) to allow the user a convenient way to deny the connection request. Also, the alert (502) may include an accept button (514) to provide the user with a convenient way to accept the connection request. If the user decides to accept the connection request despite the information presented in the alert (502), the user may chose an access level connection to initially create from a drop down menu (516).

FIG. 6 is a diagram showing an illustrative processor (600). In this example, the processor (600) includes a central processing unit (CPU) (602) in communication with an input/output (604). The input/output (604) may be in communication with a server that runs at least a portion of a social network, the user's computer, the contact's computer, other devices, or combinations thereof.

In FIG. 6, the CPU (602) may be in communication with a connection request identifier (606) that may identify connection requests. The connection requests may be sent to the server or directly from the computers of either the user or the contact. A profile reader (608) may read the profile of the contact making the connection request, and a preference identifier (610) may identify the user's preferences. The processor (600) may also have an information comparer (612) to compare the information in the contact's profile with the information in the user's preferences and determine whether any matches exist. An undesirability index generator (614) may generate an undesirability value based on the matches found by the information comparer (612).

An allowance determiner (616) may determine whether to allow or disallow the connection request from being sent to the user's profile. In some examples, the allowance determiner (616) determines to disallow the connection request based on an undesirability value of the undesirability index. In some examples, the allowance determiner (616) determines whether to disallow the connection request based on the user's level of access preferences. If the allowance determiner (616) determines to disallow the connection request from being sent, a connection request disallower (618) may prevent the connection request from being sent.

If the allowance determiner (616) determines to send the connection request to the user's profile, an alert generator (620) may generate an alert to accompany the connection request. In some examples, an alert accompanies just those connection requests that contain at least one match between an undesirability preference and information in the contact's profile. In other examples, an alert accompanies any connection request that is allowed to be sent even if no matches exist. In such an example, the alert may indicate to the user that no matches exist and the user may use that information when determining to accept the connection request.

In some examples, an access level determiner (622) of the processor (600) determines what the access level connection will be if the user accepts the connection request. In some examples, the access level determiner (622) determines the access level based on the undesirability value of the undesirability index. In some examples, the access level determiner (622) determines the access level based on the user's access level preferences. In some examples, the user has an option to modify the access level after the connection is established.

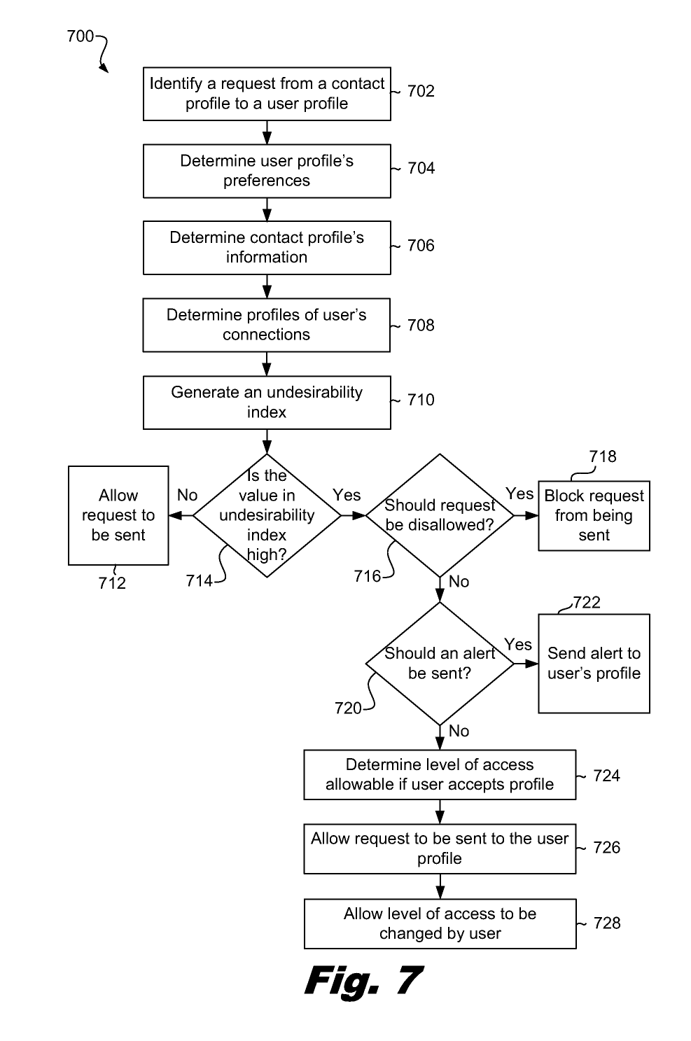

FIG. 7 is a diagram showing an illustrative flowchart (700) of a process for monitoring connection requests. In this example, the process includes identifying (702) a connection request from a contact's profile to a user's profile and determining (704) the preferences in the user's profile. The process may also include determining (706) the information in the contact's profile. This information may be personal information, links in the website, recent activity recorded by the profile, the type of connections already established with the contact's profile, other information, or combinations thereof. In some examples, the process includes determining (708) the information in profiles of the user's connections. The information in the profiles of the user's connections may be used to determine if any of the user's connections have found the contact undesirable. For example, in carrying out the process it may be discovered that the contact has posted undesirable comments on other profiles in the social network.

The process may also include generating (710) an undesirability index that may be based on matches between the undesirability preferences of the user and the information in the contact's profile. The undesirability index may include an undesirability value that is weighted as specified by the user. In other examples, each match is weighted substantially the same when generating the undesirability value. The process may also include determining (712) whether the undesirability index's value is high. In some examples, the undesirability index's value is considered high if the value exceeds a predetermined value threshold. In some examples, the user may designate the value threshold.

In the example of FIG. 7, if the undesirability index's value is not determined to be high, then the process may include allowing (714) the connection request to be sent to the user's profile. In response to receiving the connection request, the user may decide whether to accept or deny the connection request.

If the undesirability index's value is determined to be high, then the process may include determining whether (716) whether the connection request should be disallowed from being sent to the user's profile. If it is determined that the connection request should be disallowed, then the process may include blocking (718) the connection request from being sent to the user's profile.

The process may also include determining (720) whether an alert should be sent with the connection request. If so, then the process may include sending (722) an alert with the connection request to alert the user that the connection request is from a contact that has at least some probability of being an undesirable connection.

In the example of FIG. 7, if the process decides not to send an alert with the connection request, then the process includes determining (724) the level of access that should be allowable to initially establish a connection if the user decides to accept the connection request. The process may also include allowing (726) the connection request to be sent to the user's profile. If the user determines to accept the connection request, the process may also include allowing (728) the level of access to be changed by the user.

While the above examples have been described with specific types of information in a contact's profile to determine whether the contact matches an undesirability preference of the user, any type of information that is contained in the contact's profile may used. Further, while the above examples have been described with specific types of undesirability preferences, the user may use any type of preference to identify the types of connections that the user deems to be undesirable. In some examples, if a profile does not incorporate a specific type of undesirability preference, the profile may include an option to customize specific preferences according to the user's desires.

In some examples, the social network is a web-based network where the user's profiles are stored on servers and memory located outside of their personal computers or other personal devices used to access their profiles. In other examples, the social network is a client based network where the user's information is stored on the personal computers or other personal devices used by the user to access the information in their profiles.

Further, while the above examples have been described with specific levels of access, any type of restriction may be provided to the user to restrict as much or as little access to specific contacts as desired. In some examples, the user has an option to customize the level of access according to the user's desires. Also, while the default access level has been described above as providing no restriction to the user's contacts, the default access level may be customize based on the user's input.

In some examples, the contact receives a message through the social network indicating the contact's connection request was disallowed. In this manner, the contact may be notified that the user did not receive the connection request based on pre-identified criteria. In other examples, the contact receives no information as to why the connection has not been accepted.

While the examples of the alerts described above have included a specific format and specific types of information, any format and any type of information may be provided in the alert. In some examples, some of the information in the contact's profile may be private information that has a restricted access level. In such examples, the alert may indicate generally the reason why the index's undesirability value is as high as it is without disclosing the private information about the contact.

The descriptions of the various examples of the present invention have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

What is claimed is:

1. A method for monitoring connection requests in social networks, comprising:
identifying a connection request to connect a contact's profile to a user's profile in said social network;
comparing information about said contact's profile to a preference in said user's profile; and
determining whether to allow said connection request to be sent to said user's profile based on said preference.

2. The method of claim 1, wherein comparing information about said contact's profile to a preference in said user's profile includes comparing said preference to links in said contact's profile, group memberships in said contact's profile, or combinations thereof.

3. The method of claim 1, wherein comparing information about said contact's profile to a preference in said user's profile includes comparing said preference to job title information in said contact's profile.

4. The method of claim 1, wherein comparing information about said contact's profile to a preference in said user's profile includes determining a job relationship with information from said user's profile, said contact's profile, secondary connections in said contact's profile, or combinations thereof.

5. The method of claim 1, wherein comparing information about said contact's profile to a preference in said user's profile includes comparing said preference to employer information in said contact's profile.

6. The method of claim 1, wherein comparing information about said contact's profile to a preference in said user's profile includes comparing said preference to relationship information in said contact's profile, to secondary connections in said contact's profile, or combinations thereof.

7. The method of claim 1, wherein comparing information about said contact's profile to a preference in said user's profile includes comparing said preference to information in another social network contact's profile.

8. The method of claim 1, wherein comparing information about said contact's profile to a preference in said user's profile includes generating an undesirability index for said contact's profile based on said preference.

9. The method of claim 8, wherein generating an undesirability index for said contact's profile based on said preference includes computing said undesirability index based on assigned weights specified in said user's profile.

10. The method of claim 1, wherein determining whether to allow said connection request to be sent to said user's profile based on said preference includes determining to disallow said connection request.

11. The method of claim 1, wherein determining whether to allow said connection request to be sent to said user's profile based on said preference includes sending an alert about said connection request.

12. The method of claim 11, wherein said alert includes at least one reason for sending said alert.

13. The method of claim 1, wherein determining whether to allow said connection request to be sent to said user's profile based on said preference includes allowing a limited access connection between said contact's profile and said user's profile.

14. The method of claim 13, wherein allowing a limited access connection between said contact's profile and said user's profile includes allowing modifications to said limited access connection after said connection request is sent.

15. A system for monitoring connection requests in social networks, comprising:
at least one processor to access and execute computer readable instructions stored on a computer readable storage medium;
said computer readable instructions to cause said at least one processor to
identify a connection request to invite a contact's profile to connect with a user's profile in a social network;
compare information about said contact's profile to a preference in said user's profile; and
determine whether to allow said connection request to be sent to said user's profile based on said preference.

16. The system of claim 15, wherein to determine whether to allow said connection request to be sent to said user's profile based on said preference includes sending an alert to said user's profile.

17. The system of claim 15, wherein to determine whether to allow said connection request to be sent to said user's profile based on said preference includes disallowing said connection request from being sent.

18. A computer program product, comprising:
a computer readable storage medium, said computer readable storage medium comprising computer readable program code embodied therewith, said computer readable program code comprising:
computer readable program code to identify a connection request from a contact's profile to connect to a user's profile; and
computer readable program code to generate an undesirability index for said contact's profile based on a preference in said user's profile.

19. The computer program product of claim 18, further comprising computer readable program code to disallow said connection request from being sent to said user's profile.

20. The computer program product of claim 18, further comprising computer readable program code to allow said connection request to be sent and to allow a limited access connection to be made between said contact's profile and said user's profile.
